(19) United States
(12) Patent Application Publication
(10) Pub. No.: US 2022/0065637 A1
(43) Pub. Date: Mar. 3, 2022

(54) IDENTIFYING RISK USING IMAGE ANALYSIS

(71) Applicant: Capital One Services, LLC, McLean, VA (US)

(72) Inventors: Chih-Hsiang CHOW, Plano, TX (US); Steven DANG, Plano, TX (US); Elizabeth FURLAN, Plano, TX (US)

(73) Assignee: Capital One Services, LLC, McLean, VA (US)

(21) Appl. No.: 17/003,208

(22) Filed: Aug. 26, 2020

(51) Int. Cl. G01C 21/34; G06Q 40/02; G06Q 40/06; G06K 9/32

(52) U.S. Cl. CPC G01C 21/3446; G06Q 40/025; G06K 9/325; G01C 21/3461; G06Q 40/06

(57) ABSTRACT

Provided herein are system, apparatus, device, method and/or computer program product embodiments, and/or combinations and sub-combinations thereof, for identifying risk using image analysis. In an embodiment, a server receives an image, including a vehicle from a camera. The server identifies an event occurring in the image. The server uses the event and the factors identify an attribute associated with the vehicle. The server generates a risk value for the vehicle based on the attribute.

### BACKGROUND

Driving routes often times pose various risks to drivers. The risks may include the condition of the road, weather conditions, traffic, average speed, terrain, or the like. However, it may be difficult to identify the various risks, as they may not be readily apparent. Furthermore, conventional systems use limited amount of information to gauge a risk of a given route. As a result, conventional systems may generate inaccurate risk assessments.

### BRIEF DESCRIPTION OF THE FIGURES

The accompanying drawings, which are incorporated herein and form part of the specification, illustrate the present disclosure and, together with the description, further serve to explain the principles of the disclosure and enable a person skilled in the relevant art to make and use the disclosure.

FIG. 1 is a block diagram of an example environment in which systems and methods described herein may be implemented.

FIGS. 2A-2B are example images of vehicles captured by a camera according to an example embodiment.

FIG. 3 is a flowchart illustrating a process for generating an attribute for a vehicle according to an embodiment.

FIG. 4 is a flowchart illustrating a process for applying a risk value to a loan portfolio according to an embodiment.

FIG. 5 is a flowchart illustrating a process for identifying an event in an image according to an embodiment.

FIG. 6 is a block diagram of example components of a device according to an embodiment.

The drawing in which an element first appears is typically indicated by the leftmost digit or digits in the corresponding reference number. In the drawings, like reference numbers may indicate identical or functionally similar elements.

### DETAILED DESCRIPTION

Provided herein are system, apparatus, device, method and/or computer program product embodiments, and/or combinations and sub-combinations thereof, for identifying risk using image analysis.

In an embodiment, a server receives information about a route on which a vehicle is traveling. The server retrieves a set of travel histories specifying data describing trips the vehicle and other vehicles have made along the route and road incidents in which the vehicle and other vehicles have been involved. Furthermore, the server determines a frequency at which the route is traveled by the vehicle based on a travel history of the vehicle from the set of travel histories. The server identifies each occurrence of a type of road incident on the route from the set of travel histories and determines a route risk value based on a number of occurrences of the type of road incident being more than a threshold amount. Additionally, the server receives an image including the vehicle and executes image analysis on the image to identify an event occurring in the image based on an object's relation to the vehicle in the image using a deep learning algorithm. The server uses the frequency at which the route is traveled by the vehicle, the route risk value, and the event to determine an attribute of the vehicle.

The system solves the technical problem of being able to identify vehicle driver information based on an identified pattern. This configuration allows for vehicle driver information to be captured and provided in (near) real-time. As such, this allows the system to assess a risk factor associated with the vehicle based on the vehicle driver information, quicker than conventional methods. Furthermore, by capturing vehicle driver information and provided in (near) real-time, the system can accurately generate a risk assessment score for the driver.

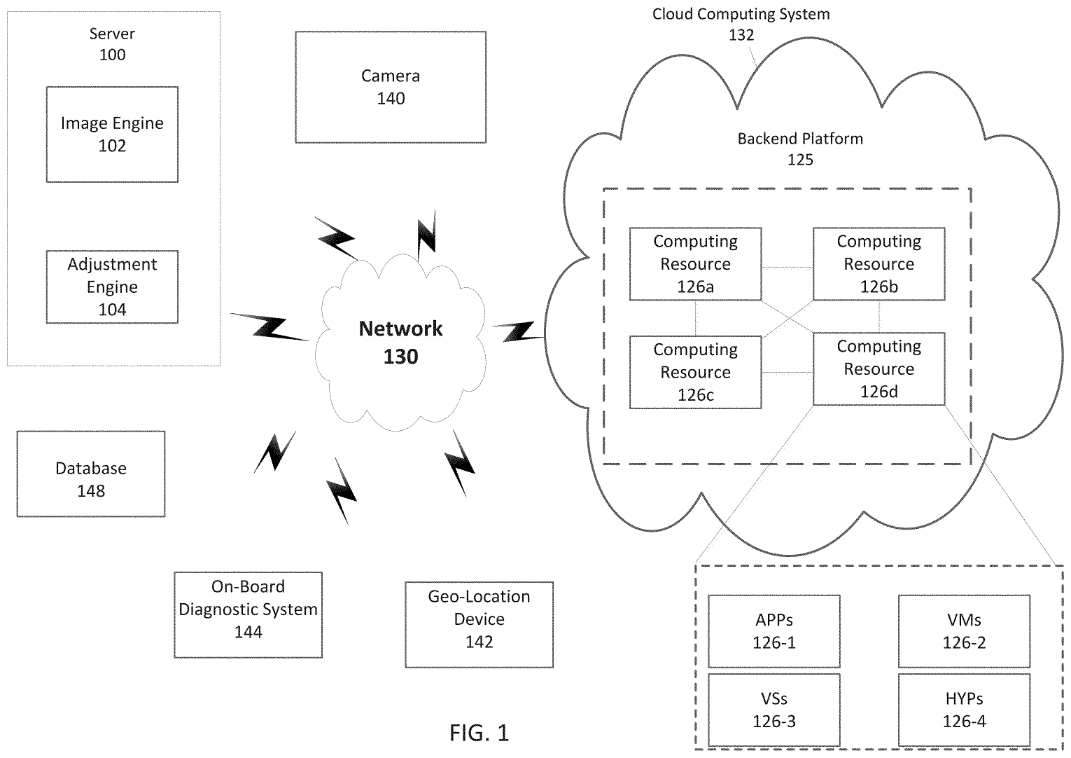

FIG. 1 is a block diagram of an example environment in which systems and/or methods described herein may be implemented. The environment may include server 100. The server may include an image engine 102 and an adjustment engine 104. The environment may further include a camera 140, geo-location device 142, onboard diagnostics system (OBD) 144, and database 148. Geo-location device 142 and OBD system 144 may be disposed within a vehicle. For example, geo-location device 142 may be a Global Positioning System (GPS) device. The geo-location device 142 can be included in a navigation system or mobile device of a vehicle's driver. The vehicle's driver can be the vehicle's owner or some other person operating the vehicle.

OBD system 144 may be a vehicle's self-diagnostic and reporting system. OBD system 144 may include one or more devices to capture different types of data associated with a vehicle in which it is disposed. For example, OBD system 144 may capture real-time parameters: engine RPM (rotations per minute), vehicle speed, accelerator and brake pedal position, ignition timing, airflow rate into the engine, coolant temperature, or the like. Furthermore, OBD system 144 may capture or store Vehicle Identification Number (VIN), number of ignition cycles, emission readiness status, miles driven with malfunction indicator lamp on, or the like. Database 148 may store information about the vehicle and the vehicle's driver(s).

In an embodiment, camera 140 may be disposed within the vehicle. Camera 140 may be assigned to the owner of the vehicle by an entity administrating server 100. An identifier of the camera may be stored in database 148. The identifier may be correlated with other information regarding the owner of the vehicle and the vehicle itself. Alternatively, camera 140 may not be affiliated with the entity administrating server 100. For example, camera 140 may be disposed on signposts or traffic signals. Camera 140 may be configured to transmit still or moving images to server 100.

The devices of the environment may be connected through wired connections, wireless connections, or a combination of wired and wireless connections. In an example embodiment, one or more portions of the network 130 may be an ad hoc network, an intranet, an extranet, a virtual private network (VPN), a local area network (LAN), a wireless LAN (WLAN), a wide area network (WAN), a wireless wide area network (WWAN), a metropolitan area network (MAN), a portion of the Internet, a portion of the Public Switched Telephone Network (PSTN), a cellular telephone network, a wireless network, a WiFi network, a WiMax network, any other type of network, or a combination of two or more such networks.

The backend platform 125 may include a server or a group of servers. In an embodiment, the backend platform 125 may be hosted in a cloud computing environment 132. It may be appreciated that the backend platform 125 may not be cloud-based, or may be partially cloud-based.

The cloud computing environment 132 includes an environment that delivers computing as a service, whereby shared resources, services, etc. may be provided to server 100. The cloud computing environment 132 may provide computation, software, data access, storage, and/or other services that do not require end-user knowledge of a physical location and configuration of a system and/or a device that delivers the services. The cloud computing system 132 may include computer resources 126a-d. Server 100 may reside inside the cloud computing environment 132. Alternatively, server 100 may reside partially outside the cloud computing environment 132 or entirely outside the cloud computing environment 132.

Each computing resource 126a-d includes one or more personal computers, workstations, server devices, or other types of computation and/or communication devices. The computing resource(s) 126a-d may host the backend platform 125. The cloud resources may include compute instances executing in the cloud computing resources 126a-d. The cloud computing resources 126a-d may communicate with other cloud computing resources 126a-d via wired connections, wireless connections, or a combination of wired and wireless connections.

Computing resources 126a-d may include a group of cloud resources, such as one or more applications (“APPs”) 126-1, one or more virtual machines (“VMs”) 126-2, virtualized storage (“VS”) 126-3, and one or more hypervisors (“HYPs”) 126-4.

Application 125-1 may include one or more software applications that may be provided to or accessed by server 100. In an embodiment, server 100 may reside outside the cloud computing environment 132 and may execute applications like image engine 102 and adjustment engine 104 locally. Alternatively, the application 126-1 may eliminate a need to install and execute software applications on server 100. The application 126-1 may include software associated with backend platform 125 and/or any other software configured to be provided across the cloud computing environment 132. The application 126-1 may send/receive information from one or more other applications 126-1, via the virtual machine 126-2.

Virtual machine 126-2 may include a software implementation of a machine (e.g., a computer) that executes programs like a physical machine. Virtual machine 126-2 may be either a system virtual machine or a process virtual machine, depending upon the use and degree of correspondence to any real machine by virtual machine 126-2. A system virtual machine may provide a complete system platform that supports execution of a complete operating system (OS). A process virtual machine may execute a single program and may support a single process. The virtual machine 126-2 may execute on behalf of a user and/or on behalf of one or more other backend platforms 125, and may manage infrastructure of cloud computing environment 132, such as data management, synchronization, or long-duration data transfers.

Virtualized storage 126-3 may include one or more storage systems and/or one or more devices that use virtualization techniques within the storage systems or devices of computing resource 126. With respect to a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how administrators manage storage for end users. File virtualization may eliminate dependencies between data accessed at a file level and location where files are physically stored. This may enable optimization of storage use, server consolidation, and/or performance of non-disruptive file migrations.

Hypervisor 126-4 may provide hardware virtualization techniques that allow multiple operations systems (e.g., “guest operating systems”) to execute concurrently on a host computer, such as computing resource 126. Hypervisor 126-4 may present a virtual operating platform to the guest operating systems and may manage the execution of the guest operating systems multiple instances of a variety of operating systems and may share virtualized hardware resources.

In an embodiment, camera 140 may be assigned by an entity to a vehicle owner. Camera 140 may be installed inside a vehicle. For example, the entity may be an administrator of server 100. Example entities may include banks, financial institutions, or other entities that provide vehicle loans to customers. The identifier of camera 140 may be stored in database 148 and correlated with the information about the vehicle and the owner of the vehicle.

As described above, geo-location device 142, OBD system 144, and camera 140 may be in communication with server 100 through network 130. Based on the vehicle's owner or vehicle's driver consent, geo-location device 142, OBD system 144, and camera 140 can be configured to transmit data to server 100.

The camera 140, geo-location device 142, and OBD system 144 may be configured to act as Internet of Things (IoT) devices. In this regard, the geo-location device 142 and OBD system 144 may periodically transmit captured data to server 100, and thusly, server 100 may periodically receive data captured by geo-location device 142 and OBD system 144. The data may include the location of the vehicle and real-time vehicle data such as RPM, speed, pedal position, spark advance, airflow rate, coolant temperature, or the like. Based on the received data, server 100 may determine that a driver of the vehicle is driving dangerously. For example, based on the location of the vehicle, server 100 may determine that the vehicle is in a neighborhood street.

Additionally, based on the speed and RPM data, server 100 may determine that the driver is driving over the speed limit of the neighborhood street. In an embodiment, server 100 may store records of drivers who drive on particular routes in database 148. For example, server 100 may store average speeds traveled, speeding tickets, accidents, or the like. In an embodiment, server 100 may store occurrences of driving over the speed limit, or other relevant data received from geo-location device 142 and OBD system 144 in database 148.

Geo-location device 142 and OBD system 144 can transmit data about a vehicle while the vehicle is traveling on a given route to server 100. Server 100 can determine that the vehicle is being driven dangerously or recklessly, based on the data received from geo-location device 142 and OBD system 144.

In response to determining that the vehicle is being driven dangerously or recklessly, server 100 may control the operation of camera 140 disposed in the vehicle to make camera 140 operational. In response to becoming operational, camera 140 may capture an image and transmit the image to server 100. In an embodiment, camera 140 may capture multiple different images from different angles and transmit the images to server 100. These images may capture the surroundings of the vehicle. The image may capture the vehicle and another object. The other object may be another vehicle, a traffic signal, a traffic sign, debris on the road, or the like. The images may capture the driver of the vehicle violating traffic regulations (e.g., running red lights, stop signs, not yielding, or the like). The images may also capture a collision between the vehicle and another object.

In an embodiment, camera 140 may be operational in a continuous manner. Moreover, camera 140 may continuously capture images. The images may include events such as reckless driving of the vehicle, speeding, accidents of other vehicles on a route traveled by the vehicle, or the like. Camera 140 may continuously transmit the captured images to server 100. Server 100 may identify the events in the images using a deep learning algorithm as will be described below.

In an embodiment, camera 140 may not be disposed within the vehicle and may not be assigned by the entity. In response to server 100 identifying particular data received from the geo-location device 142 and OBD system 144 of a vehicle, server 100 may search for a camera accessible to server 100 near the location of the vehicle. Server 100 may identify camera 140. Camera 140 may be disposed on a traffic signal, signpost, building, or the like. With the permission of the owner and operator of camera 140, camera 140 may transmit recently captured images to server 100.

Server 100 may receive the image(s) and image engine 102 may execute image analysis on the image(s). Image engine 102 may use a deep learning algorithm, such as a convolutional neural network (CNN), to identify events occurring in the image. The CNN algorithm may be used to analyze visual imagery to identify objects or events in an image.

The CNN algorithm may be trained by two phases, a forward phase, and a backward phase. The forward phase includes a convolution layer, pooling layer, and fully-connected layer. The convolution layer may apply filters to an input image to generate a feature map, the pooling layer may generate a reduced feature map, and the fully-connected layer may classify the features of the image using weights and biases. The values of the filters, weights, and biases may be parameters received by the CNN algorithm. The CNN algorithm may initially receive an input image (e.g., an image from camera 140) and randomly assigned values for filters, weights, and biases. The CNN algorithm can determine whether it correctly identified objects in the image using loss function. Next, in the backward phase, the CNN algorithm can use backpropagation to determine whether the CNN algorithm was able to identify the objects in the image correctly. The CNN algorithm can update the values for the filters, weights, and biases using a gradient descent algorithm and re-execute the forward phase on the input image. As such, the CNN algorithm can be trained to identify objects or events in the input image using feature learning and classification. Feature learning includes the convolution layer and the pooling layer. The classification includes the fully connected layer.

In the convolution layer, the CNN algorithm performs feature extraction on the input image. The CNN algorithm applies a small array of numbers (e.g., kernel) across the different portions of the input image. The kernel may also be referred to as a filter. As described above, values of the filters or kernels can be randomly assigned and optimized over time. Different filters can be applied to the input image for generating different features of maps. For example, the filter for identifying an object in the image may be different than the filter for edge detection. The kernel can be applied as a sliding window across different portions of the input image. The kernel can be summed with a given portion of the input image to generate an output value. The output value can be included in a feature map. The feature map can be a two-dimensional array. The final feature map can include an output value from the kernel applied to each portion of the input image. The features can be different edges or shapes of the image.

In the pooling layer, the CNN algorithm may reduce the dimensionality of the feature map. In particular, the CNN algorithm may extract portions of the feature map and discard the rest. Pooling the image keeps the important features while discarding the rest. This way, the size of the image is reduced. The CNN algorithm may use max or average pooling in the pooling layer to perform these operations. Max pooling keeps the higher values of portions of the feature map while discarding the remaining values. Average pooling keeps the average value of different portions of the feature map. The CNN algorithm may generate a reduced feature map in the pooling layer.

In the fully connected layer, the CNN algorithm may flatten the reduced feature map into a one-dimensional array (or vector). The fully connected layer is a neural network. The CNN algorithm performs a linear and non-linear transformation on the one-dimensional array. The CNN algorithm can perform the linear transformation by applying weights and biases to the one-dimensional array to generate an output. Initially, the weights and biases are randomly initialized and can be optimized over time. Next, the CNN algorithm can perform a non-linear transformation such as an activation layer function (e.g., softmax or sigmoid) to classify the output based on the features.

Image engine 102 may identify the events in the image(s) using the CNN algorithm. For example, the CNN algorithm may identify objects such as a vehicle, a traffic signal, the position of the vehicle relative to the traffic signal. In another example, the CNN algorithm may identify two vehicles and the distance between the two vehicles. In this regard, image engine 102 can determine an event based on these identified objects. The event may be a collision, running a traffic signal, swerving, or the like. Image engine 102 may identify the event based on the object and its relation to the vehicle in the image. For example, image engine 102 may identify the vehicle in the image and may identify another object within a given proximity to the vehicle. The object may be a traffic signal. Image engine 102 may determine that the vehicle has run a red light. In another example, image engine 102 may identify another vehicle within a given proximity to the vehicle. The image engine 102 may determine that the vehicle has been involved in a collision with the other vehicle. Furthermore, image engine 102 may determine the amount of damage of the vehicle based on the objects/aspects in the image and the collected data. Image engine 102 may store the information about the identified event(s) from the received image in database 148.

Server 100 may receive a vehicle identifier of the vehicle from the data received from geo-location device 142 and OBD system 144 or along with the image transmitted from camera 140. Alternatively, image engine 102 can identify a license plate number of the vehicle from the image. Image engine 102 can transmit the identified license plate number to server 100. The license plate number can be used as a vehicle identifier.

Server 100 may also determine information about the route being traveled by the vehicle using the data received from geo-location device 142 and OBD system 144. For example, server 100 may piece together the geo-location information received from geo-location device 142 and determine the route being traveled by the vehicle. Server 100 may store the route in database 148.

In addition to or alternatively, server 100 may receive information about the route being traveled by a vehicle from a mapping/navigation software used by the vehicle's driver. For example, the vehicle's driver may use mapping/navigation software (e.g., GOOGLE MAPS, MAPQUEST, WAZE, or the like) on the driver's mobile device for navigation to a desired destination. The vehicle's driver may opt to share the route information input in the mapping/navigation software to server 100. As such, server 100 may receive route information from the mapping/navigation software. The route information may include the Global Positioning System (GPS) coordinates of the route traveled by a driver of the vehicle, accidents on the route, speed limits of the route, construction sites on the route, or the like. Server 100 may also receive information from OBD system 144 of the vehicle while the driver is traveling on this route. Server 100 may store the route information from the mapping software, and information received from OBD system 144 in database 148.

The database 148 may designate the route information received from the mapping software and data received from geo-location device 142 and OBD system 144 as the vehicle's travel history. The vehicle's travel history may include the different routes traveled by the vehicle, road incidents in which the vehicle was involved, and other data received from geo-location device 142 and OBD system 144. Road incidents can include accidents, traffic violations, reckless driving, or the like. Database 148 may also store travel histories of other vehicles.

In an embodiment, server 100 may retrieve a set of travel histories of vehicles traveling the same route as the vehicle. The travel histories can include the travel history of the vehicle currently traveling the route as well as other vehicles. Server 100 can use the travel histories to identify each occurrence of a type of road incident in which the vehicles were involved while traveling the route. The road incidents can include accidents, traffic violations, dangerous driving, or the like. Server 100 can determine that there are more than a threshold amount of occurrences of a predetermined type of road incidents for the route. For example, server 100 can determine that there is more than a threshold amount of accidents on the route. Server 100 can assign a route risk value to the route based on determining there are more than a threshold amount of occurrences of a predetermined type of road incidents for the route. Server 100 may store the route risk value in database 148.

Server 100 can also determine a frequency at which a vehicle travels the route based on the travel history of the vehicle. Server 100 can determine the occurrences of each time the vehicle has traveled the route based on the travel history. Furthermore, server 100 can determine how often the vehicle travels the route based on the travel history. Server 100 may store the frequency in database 148.

Server 100 may also compare the vehicle's travel history with the travel histories of other vehicles that have traveled the same route. Server 100 may determine that the driver is driving more dangerously than other drivers who travel the same route. For example, server 100 may determine the driver's average speed is more than a threshold amount than the average speed of other drivers. In light of this, server 100 may determine that the driver is driving dangerously on the route. Server 100 may store the comparison in the database 148.

Server 100 may also query third party databases to retrieve information about a vehicle. For example, image engine 102 may retrieve public records to identify any traffic violations committed by the driver(s) of the vehicle. The retrieved information may include the driving habits associated with the vehicle. The retrieved information may be stored in database 148.

Server 100 may also determine a set of routes traveled by the vehicle. The set of routes may include routes traveled with a route risk value more than a threshold amount and routes traveled with a route risk value less than a threshold amount. Sever 100 may generate a ratio of routes traveled with route risk value more than a threshold amount and routes traveled with route risk values less than a threshold amount. Server 100 may continuously update the profile of the vehicle as the vehicle travels different routes. As a result, server 100 may update the ratio

Adjustment engine 104 may use one or any combination of the following factors: identified events in the image, route risk value, frequency of the vehicle traveling the route, comparison of the vehicle's travel history with the travel history of other vehicles, the retrieved information about the vehicle, ratio of routes traveled with a higher route risk value to routes traveled with a lower route risk value, and other information about the vehicle to generate an attribute associated with the vehicle.

As a non-limiting example, the attribute can be used to generate a risk value to indicate a likelihood of repayment of a loan. For example, if the vehicle is likely to be involved in an accident, the likelihood of repayment of the loan is less. The higher the risk value, the lower the chances of repayment of the loan. Conversely, the lower the risk value, the higher the chances of repayment of the loan. The information about the vehicle, owner of the vehicle, loan, and risk value may be stored in database 148. The loan of the vehicle may have a previously generated risk value. Adjustment engine 104 may retrieve loan information of the vehicle using the vehicle identifier. The loan information may include the total loan amount, loan term, remaining balance, and other loan information (APR, PMI, taxes, or the like). The loan information may also include a previously generated risk value.

In this regard, the attribute can be a score generated using one or more of the factors described above. Adjustment engine 104 may use the score to adjust the previously generated risk value based on whether the score is higher or lower than the previously generated risk value. If the score is higher than the previously generated risk value, adjustment engine 104 may increase the previously generated risk value, a predetermined amount to generate the risk value. If the score is lower than the previously generated risk value, adjustment engine 104 may lower the previously generated risk value, a predetermined amount to generate the risk value.

For example, server 100 may determine that the vehicle has been involved in an accident based on the event identified in the image. As such, adjustment engine 104 may increase the risk value associated with the vehicle.

In another example, server 100 may determine that the vehicle has been driven dangerously based on the event identified image (e.g., running a red light). Furthermore, server 100 may determine that route that the vehicle is currently traveling has a high route risk value as many other vehicles have been involved in accidents on this route. Server 100 may also determine that vehicle travels the route more than a threshold amount based on the frequency of the vehicle traveling the route. Server 100 may also determine that the vehicle is driven more dangerously on the route as compared to other vehicles that have traveled the same route. Lastly, server 100 may also determine that the vehicle has been involved in road incidents, such as traffic violations, accidents, or the like. Server 100 may use the above factors to generate a risk value for the vehicle.

Each of the factors may be weighted based on importance. For example, if the event identified in the image is a collision, server 100 may assign the identified event has a larger weight as compared to the other weights. In another example, if the vehicle has multiple traffic violations and a history of being driven dangerously, server 100 may assign a larger weight to the multiple traffic violations and history of being driven dangerously, as compared to other factors. Adjustment engine 104 can use the weights assigned to each of the factors to generate the risk value.

Adjustment engine 104 may further identify a loan portfolio, which includes the loan of the vehicle. The loan portfolio may include a collection of loans for different vehicles. The loan portfolio may include an aggregate amount of loan amount due for the collection of loans. The loan portfolio may have a portfolio risk value. The portfolio risk value may indicate a likelihood of repayment of the total balance of each of the loans in the collection of loans. Adjustment engine 104 may normalize the risk value of the loan against other risk values of all the loans provided by the financial institution for purchasing vehicles—to rank the risk value among all the risk values. Adjustment engine 104 may apply the new risk value of the loan to the loan portfolio. By applying the risk value to the loan portfolio, adjustment engine 104 identifies the likelihood of repayment of the total loans in the portfolio.

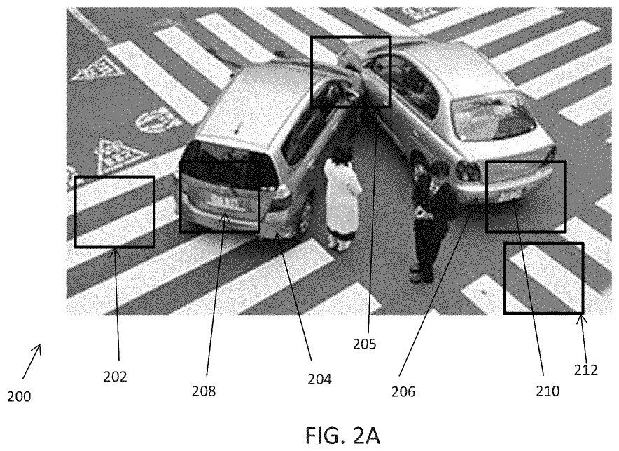

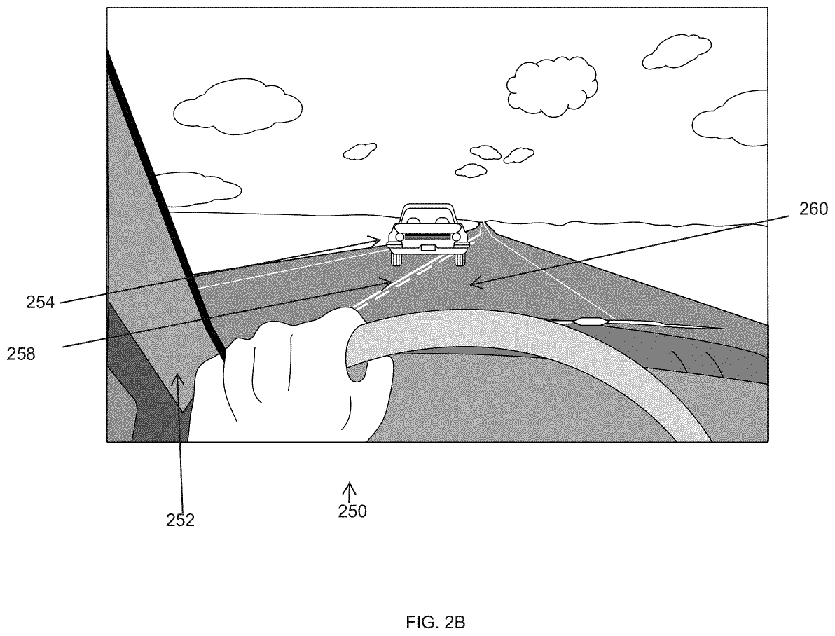

FIGS. 2A-2B are example images of vehicle collisions captured by a camera according to an example embodiment. FIGS. 2A-2B will be described in reference to FIG. 1.

FIG. 2A illustrates an image 200 depicting a collision of vehicle 204 and 206 captured by camera 140. Camera 140 may be disposed outside of a vehicle. For example, camera 140 may be disposed on a traffic light or a signpost.

Vehicle 204 may include a geo-location device 142 and OBD system 144 that is in communication with server 100. Geo-location device 142 and OBD system 144 may transmit data about the vehicle 204 to server 100.

In response to identifying particular information from the received data, server 100 may search for a camera within a vicinity of the vehicle 204. Server 100 may search for a camera based on the vehicle 204's location information received from geo-location device 142. Server 100 may identify camera 140.

Server 100 may transmit a request to camera 140 to transmit images captured in the past for a given period of time. Camera 140 may transmit images, including image 200, to server 100. Image engine 102 may implement a CNN algorithm to identify aspects/objects in image 200. Image engine 102 may identify crosswalk 202, vehicle 204, vehicle 206, and crosswalk 212. Image engine 102 may identify vehicle 206's location relative to vehicle 204 based on a point of impact 205 between vehicle 206 and vehicle 204. Image engine 102 may identify an event in image 200 based on the vehicle 206's location in relation to vehicle 204. The event may be a collision between vehicle 204 and 206. Image engine 102 may determine the amount of damage to vehicle 204 based on image 200.

Image engine 102 may also determine that the driver of vehicle 204 was driving dangerously before colliding with vehicle 206 based on the data received from geo-location device 142 and OBD system 144 and the position of the vehicle 204 in relation to vehicle 206, crosswalk 202, and crosswalk 212. Image engine 102 may generate a score indicating a danger level at which the vehicle 204's driver was driving.

Image engine 102 may also identify vehicle 204's license plate 208 and vehicle 206's license plate 210 from the image 200. Image engine 102 may extract vehicle 204's license plate number from the license plate 208 and vehicle 206's license plate number from the license plate 210.

Image engine 102 may use vehicle 204's license plate number to determine that a loan was provided to vehicle 204's owner for purchasing vehicle 204. Adjustment engine 104 may use the identified event and information from image 200 and any of the other factors described above to generate an attribute associated with vehicle 204. The attribute can be used to generate a risk value for the loan of vehicle 204 as well as the risk value of the loan portfolio including the loan of vehicle 204.

FIG. 2B illustrates an image 250 captured by camera 140. Camera 140 may be disposed inside the vehicle 252. In response to identifying particular data from data received from geo-location device 142 and OBD system 144, server 100 can make camera 140 operational. In this example, server 100 may determine that vehicle 252 is driving over the speed limit, based on the received data.

Camera 140 may capture a series of images, including image 250. Camera 140 may transmit image 250 to server 100. Image engine 102 may execute the CNN algorithm to identify aspects/objects in image 250. Image engine 102 may identify vehicle 254, the road 260, and lane divider 258.

Image engine 102 may identify an event in the image. The event may be that the driver of vehicle 252 is driving recklessly based on the speed at which vehicle 252 is traveling, the location of vehicle 252 on the road 260, the location of vehicle 254 in relation to the lane divider 258, and the location of vehicle 252 in relation to vehicle 254.

Adjustment engine 104 may use the identified event and any of the other attributes described above to generate an attribute associated with vehicle 254. The attribute can be used to generate a risk value for the loan of vehicle 254 as well as the risk value of the loan portfolio including the loan of vehicle 254.

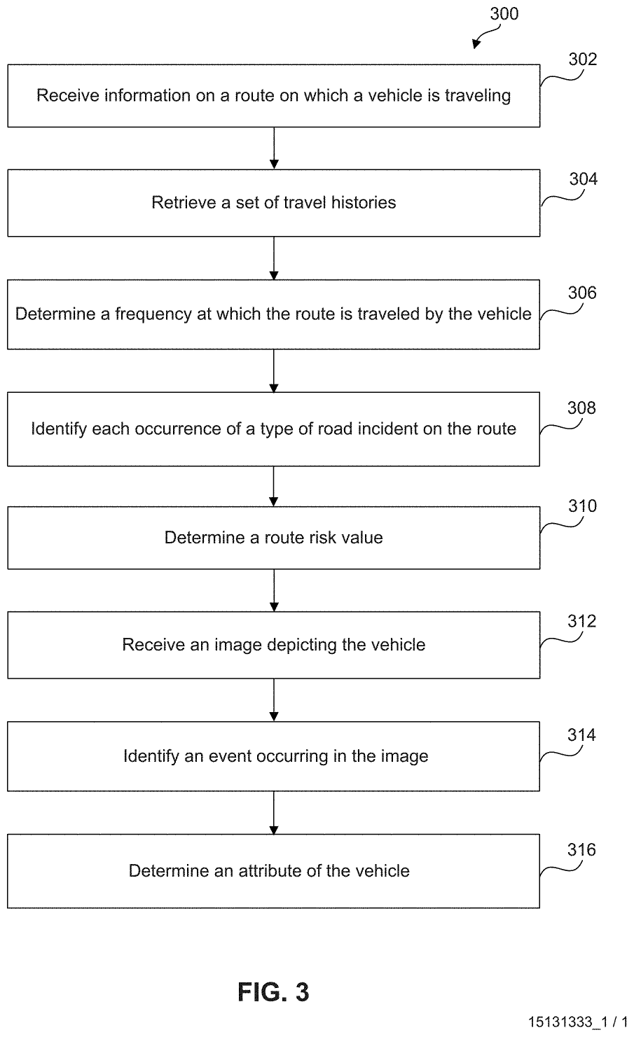

FIG. 3 is a flowchart illustrating the process for generating an attribute for a vehicle. Method 300 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps can be performed simultaneously or in a different order than shown in FIG. 3, as will be understood by a person of ordinary skill in the art.

Method 300 shall be described with reference to FIG. 1. However, method 300 is not limited to that example embodiment.

In operation 302, server 100 receives information on a route on which a vehicle is traveling. Server 100 may receive information from the vehicle's OBD system 144. Alternatively or in addition to, server 100 may receive information from the driver's mobile device map applications (e.g., GOOGLE MAPS, MAPQUEST, WAZE, or the like). The information from OBD system 144 may include RPM, speed, pedal position, spark advance, airflow rate, coolant temperature, or the like. The information from the map application may include a route being traveled by the vehicle. Server 100 may also receive information from a geo-location device 142. Geo-location device 142 may be coupled to the vehicle or the driver's mobile device. Geo-location device 142 may transmit the GPS location of the vehicle to server 100 periodically. Server 100 can determine the route being traveled by the vehicle based on the GPS location provided by geo-location device 142. Server 100 may also receive data associated with the route from the map application. The data associated with the route may include information about accidents, constructions, weather, or the like, associated with the route.

In operation 304, server 100 retrieves a set of travel histories specifying data describing trips the vehicle and other vehicles have made along the route and road incidents in which the vehicles and other vehicles have been involved. The travel histories may include the routes traveled by the vehicles. Furthermore, road incidents may include traffic violations, dangerous or reckless driving, accidents, or the like.

In operation 306, server 100 determines a frequency at which the route is traveled by the vehicle based on a travel history of the vehicle from the set of travel histories. The server 100 may identify each occurrence of the vehicle traveling the route in the travel history.

In operation 308, server 100 identifies each occurrence of a type of road incident on the route from the set of travel histories. For example, server 100 may identify each of the occurrences of vehicles traveling on the route that includes specific incidents such as traffic tickets, accidents, or the like, from the travel histories.

In operation 310, server 100 determines a route risk value based on a number of occurrences of the type of road incident being more than a threshold amount. For example, server 100 can determine that the number of accidents on the route is more than a threshold amount, and thereby classifying the route as a high risk to travel. The higher the route risk value, the higher risk of an accident or other type of road incident.

In operation 312, server 100 receives an image depicting the vehicle. The image may be captured by a camera that may be disposed within or outside the vehicle. The image may include an object other than the vehicle. The object may be a different vehicle, traffic light, traffic sign, pedestrian, sidewalk, curb, building, or the like.

In operation 314, an image engine 102 identifies an event occurring in the image based on an object's relation to the vehicle in the image by executing image analysis on the image using a deep learning algorithm. The event may include an accident, running a stop sign, running a traffic signal, or the like. Image engine 102 may use CNN to perform the image analysis.

In operation 316, server 100 determines an attribute of the vehicle, based on the frequency at which a set of routes is traveled by the vehicle with route risk values more than a threshold amount, and the event. For example, server 100 determines that the vehicle travels on the set of routes with a high route risk value more than a threshold amount of times in a given time period. Server 100 may also determine a ratio of routes traveled with route risk value more than a threshold amount and routes traveled with route risk values less than a threshold amount. Server 100 may continuously update the profile of the vehicle as the vehicle travels different routes. As a result, server 100 may update the ratio. Lastly, server 100 may determine that the vehicle was involved in a collision while traveling the route. Based on these factors, server 100 may identify an attribute that indicates that the vehicle is being driven dangerously in dangerous conditions. The attribute can be a score. The more dangerous a vehicle is being driven, the higher the score. For example, a score of a vehicle that is involved in an accident is higher than a score for a vehicle that has had traffic violations.

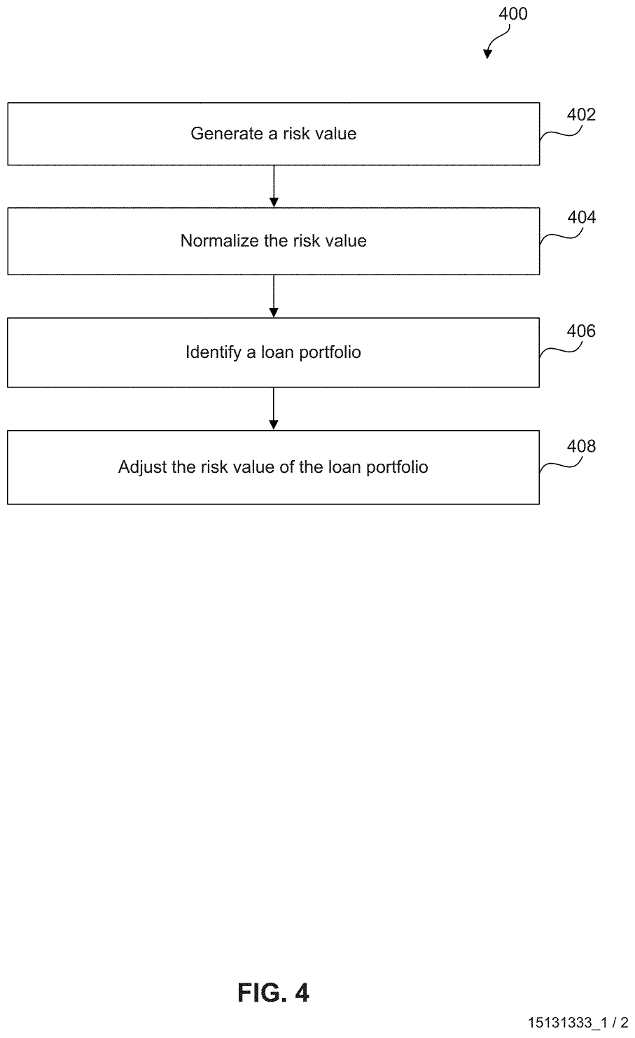

FIG. 4 is a flowchart illustrating the process for applying a risk value to a loan portfolio. Method 400 can be performed by processing logic that can comprise hardware (e.g., circuitry, dedicated logic, programmable logic, microcode, etc.), software (e.g., instructions executing on a processing device), or a combination thereof. It is to be appreciated that not all steps can be needed to perform the disclosure provided herein. Further, some of the steps can be performed simultaneously or in a different order than shown in FIG. 4, as will be understood by a person of ordinary skill in the art.

Method 400 shall be described with reference to FIG. 1. However, method 400 is not limited to that example embodiment.

In operation 402, adjustment engine 104 generates a risk value for a loan for the vehicle based on an attribute generated in operation 316 in FIG. 3. As indicated above, the attribute can be a score. Adjustment engine 104 may retrieve the loan information from the database using either the camera identifier or vehicle identifier. Adjustment engine 104 may use the score to adjust the previously generated risk value based on whether the score is higher or lower than the previously generated risk value. If the score is higher than the previously generated risk value, adjustment engine 104 may increase the previously generated risk value, a predetermined amount to generate the risk value. If the score is lower than the previously generated risk value, adjustment engine 104 may lower the previously generated risk value, a predetermined amount to generate the risk value.

In the event the camera is assigned by the financial institution providing the loan for the vehicle, the camera identifier may be stored in database 148 and correlated with the vehicle loan information. Alternatively, if camera 140 is owned and operated by a third party, adjustment engine 104 may use the vehicle identifier to retrieve the relevant loan information. The risk value may indicate the likelihood of repayment of the loan based on the attribute. For example, the higher the score indicating the danger level of the detected event may indicate a less likelihood of repayment of the loan. In this regard, the generated risk value may be higher than the previously generated risk value based on a lesser likelihood of repayment of the loan.

In operation 404, adjustment engine 104 normalizes the risk value against all risk values of all other loans issued by an entity. Normalizing the risk value may include ranking the risk value with all the other risk values of all the other loans.

In operation 406, an adjustment engine 104 identifies a loan portfolio, including a loan of the vehicle, including a new risk value. The loan portfolio may include a collection of loans provided to different customers for purchasing vehicles. The loans may include unpaid balances for various customers. Each of those loans may include a risk value for each particular loan.

In operation 408, adjustment engine 104 adjusts the risk value of the loan portfolio based on the risk value of the loan. For example, if the risk value of the loan is higher than the previously generated risk value for the loan, the risk value of the loan portfolio is increased by a predetermined amount. Alternatively, if the risk value of the loan is lower than the previously generated risk value for the loan, the risk value of the loan portfolio is reduced by a predetermined amount. The higher the risk value, the lower the likelihood of repayment of the aggregate amount due of the collection of loans in the loan portfolio. Conversely, the lower the risk value, the higher the likelihood of repayment of the aggregate amount due of the collection of loans in the loan portfolio.

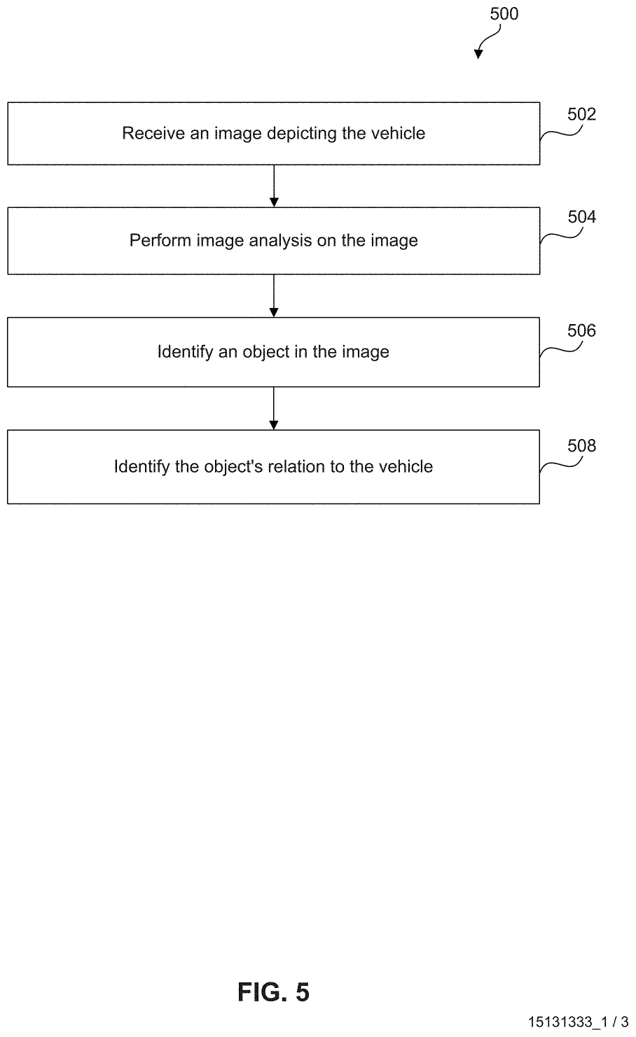

FIG. 5 is a flowchart illustrating the process for identifying an event in an image, including the image. Method 500 can be performed by processing logic that can comprise hardware (e.g., circuitry, dedicated logic, programmable logic, microcode, etc.), software (e.g., instructions executing on a processing device), or a combination thereof. It is to be appreciated that not all steps can be needed to perform the disclosure provided herein. Further, some of the steps can be performed simultaneously or in a different order than shown in FIG. 5, as will be understood by a person of ordinary skill in the art.

Method 500 shall be described with reference to FIG. 1. However, method 500 is not limited to that example embodiment.

In operation 502, a server 100 receives an image depicting the vehicle. The image may be captured by a camera. The camera may be disposed inside the vehicle or outside the vehicle.

In operation 504, an image engine 102 performs image analysis on the image using a deep learning algorithm such as CNN. The deep learning algorithm may identify various elements within the image.

In operation 506, image engine 102 identifies an object in the image using the deep learning algorithm. The object may be a different vehicle, traffic light, traffic sign, pedestrian, sidewalk, curb, building, or the like.

In operation 508, image engine 102 identifies the object's relation to the vehicle in the image using the deep learning algorithm, such as CNN. For example, image engine 102 may determine the vehicle has collided with the object based on the proximity of the object to the vehicle. Alternatively, if the object is a traffic signal, image engine 102 may determine that the vehicle has crossed a red light.

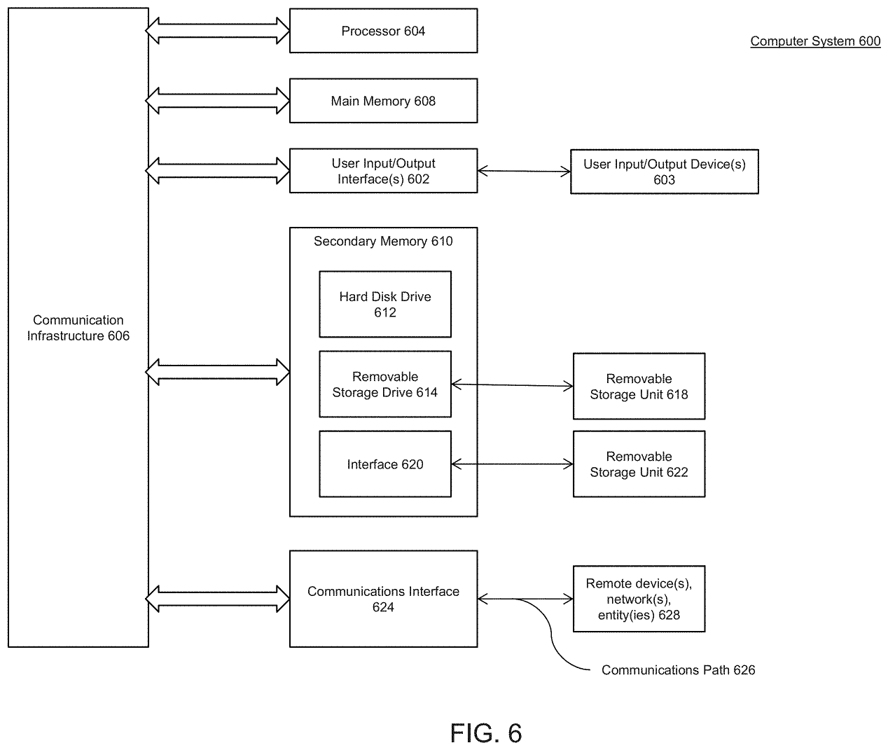

FIG. 6 is a block diagram of example components of computer system 600. One or more computer systems 600 may be used, for example, to implement any of the embodiments discussed herein, as well as combinations and sub-combinations thereof. Computer system 600 may include one or more processors (also called central processing units, or CPUs), such as a processor 604. Processor 604 may be connected to a communication infrastructure or bus 606.

Computer system 600 may also include user input/output interface(s) 602, such as monitors, keyboards, pointing devices, etc., which may communicate with communication infrastructure 606 through user input/output interface(s) 603

One or more of processors 604 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 600 may also include a main or primary memory 608, such as random access memory (RAM). Main memory 608 may include one or more levels of cache. Main memory 608 may have stored therein control logic (i.e., computer software) and/or data.

Computer system 600 may also include one or more secondary storage devices or memory 610. Secondary memory 610 may include, for example, a hard disk drive 612 and/or a removable storage drive 614.

Removable storage drive 614 may interact with a removable storage unit 618. Removable storage unit 618 may include a computer usable or readable storage device having stored thereon computer software (control logic) and/or data. Removable storage unit 618 may be a program cartridge and cartridge interface (such as that found in video game devices), a removable memory chip (such as an EPROM or PROM) and associated socket, a memory stick and USB port, a memory card and associated memory card slot, and/or any other removable storage unit and associated interface. Removable storage drive 614 may read from and/or write to removable storage unit 618.

Secondary memory 610 may include other means, devices, components, instrumentalities or other approaches for allowing computer programs and/or other instructions and/or data to be accessed by computer system 600. Such means, devices, components, instrumentalities or other approaches may include, for example, a removable storage unit 622 and an interface 620. Examples of the removable storage unit 622 and the interface 620 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 600 may further include a communication or network interface 624. Communication interface 624 may enable computer system 600 to communicate and interact with any combination of external devices, external networks, external entities, etc. (individually and collectively referenced by reference number 628). For example, communication interface 624 may allow computer system 600 to communicate with external or remote devices 628 over communications path 626, which may be wired and/or wireless (or a combination thereof), and which may include any combination of LANs, WANs, the Internet, etc. Control logic and/or data may be transmitted to and from computer system 600 via communication path 626.

Computer system 600 may also be any of a personal digital assistant (PDA), desktop workstation, laptop or notebook computer, netbook, tablet, smartphone, smartwatch or other wearables, appliance, part of the Internet-of-Things, and/or embedded system, to name a few non-limiting examples, or any combination thereof.

Computer system 600 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 600 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 600, main memory 608, secondary memory 610, and removable storage units 618 and 622, as well as tangible articles of manufacture embodying any combination of the foregoing. Such control logic, when executed by one or more data processing devices (such as computer system 600), may cause such data processing devices to operate as described herein.

The present disclosure has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present disclosure should not be limited by any of the above-described exemplary embodiments but should be defined only in accordance with the following claims and their equivalents.

What is claimed is:

1. A computer-implemented method comprising:
receiving, by one or more computing devices, information about a route on which a vehicle is traveling;
retrieving, by the one or more computing devices, a set of travel histories specifying data describing trips the vehicle and other vehicles have made along the route and road incidents the vehicle and other vehicles have been involved in;
determining, by the one or more computing devices, a frequency at which the route is traveled by the vehicle based on a travel history of the vehicle from the set of travel histories;
identifying, by the one or more computing devices, each occurrence of a type of road incident on the route from the set of travel histories;
determining, by the one or more computing devices, a route risk value based on a number of occurrences of the type of road incident being more than a threshold amount;
determining, by the one or more computing devices, an attribute of the vehicle, based on the frequency at which the route is traveled by the vehicle and the route risk value.

2. The method of claim 1, further comprising:
receiving, by the one or more computing devices, an image of an event occurring on the route; and
executing, by the one or more computing devices, image analysis on the image to identify the event in the using a deep learning algorithm.

3. The method of claim 1, further comprising: generating, by the one or more computing devices, a risk value for a loan for the vehicle based on the attribute.

4. The method of claim 1, further comprising:
identifying, by the one or more computing devices, a loan portfolio including a collection of loans including the loan;
normalizing, by the one or more computing devices, the risk value against other risk values of other loans in the collection of loans in the loan portfolio; and
applying, by the one or more computing devices, the risk value on the loan portfolio.

5. The method of claim 1, further comprising:
receiving, by the one or more computing devices, data associated with the vehicle from a device disposed in the vehicle; and
turning on, by the one or more computing devices, a camera based on data received from the device.

6. The method of claim 5, further comprising identifying, by the one or more computing devices, a speed at which the vehicle is traveling based on the data.

7. The method of claim 5, further comprising identifying, by the one or more computing devices, a geo-location of the vehicle based on the data.

8. The method of claim 1, wherein the image includes a license plate number of the vehicle and the method further comprises identifying, by the one or more computing devices, the license plate number using the deep learning algorithm.

9. A system comprising:
a memory;
a processor coupled to the memory, the processor configured to:
receive information about a route on which a vehicle is traveling;
retrieve a set of travel histories specifying data describing trips the vehicle and other vehicles have made along the route and road incidents the vehicle and other vehicles have been involved in;
determine a frequency at which the route is traveled by the vehicle based on a travel history of the vehicle from the set of travel histories;
identify each occurrence of a type of road incident on the route from the set of travel histories;
determine a route risk value based on a number of occurrences of the type of road incident being more than a threshold amount;
determine an attribute of the vehicle, based on the frequency at which the route is traveled by the vehicle and the route risk value.

10. The system of claim 9, wherein the processor is further configured to:
receive an image of an event occurring on the route; and
execute image analysis on the image to identify the event in the using a deep learning algorithm.

11. The system of claim 9, wherein the processor is further configured to: generate a risk value for a loan for the vehicle based on the attribute.

12. The system of claim 9, wherein the processor is further configured to:
identify a loan portfolio including a collection of loans including the loan;
normalize the risk value against other risk values of other loans in the collection of loans in the loan portfolio; and
apply the risk value on the loan portfolio.

13. The system of claim 9, wherein the processor is further configured to:
receive data associated with the vehicle from a device disposed in the vehicle; and
turn on a camera based on data received from the device.

14. The system of claim 13, wherein the processor is further configured to: identify a speed at which the vehicle is traveling based on the data.

15. The system of claim 13, wherein the processor is further configured to: identify a geo-location of the vehicle based on the data.

16. The system of claim 9, wherein the image includes a license plate number of the vehicle and the method further comprising identifying, by the one or more computing devices, the license plate number using the deep learning algorithm.

17. A non-transitory computer readable medium having instructions stored thereon, execution of which, by one or more processors of a device, cause the one or more processors to perform operations comprising:
receiving information about a route on which a vehicle is traveling;
retrieving a set of travel histories specifying data describing trips the vehicle and other vehicles have made along the route and road incidents the vehicle and other vehicles have been involved in;
determining a frequency at which the route is traveled by the vehicle based on a travel history of the vehicle from the set of travel histories;
identifying each occurrence of a type of road incident on the route from the set of travel histories;
determining a route risk value based on a number of occurrences of the type of road incident being more than a threshold amount;
receiving an image including the vehicle;
executing image analysis on the image to identify an event occurring in the image based on an object's relation to the vehicle in the image using a deep learning algorithm;
determining an attribute of the vehicle, based on the frequency at which the route is traveled by the vehicle and the route risk value.

18. The non-transitory computer readable medium of claim 17, the operations further comprising:
receiving an image of an event occurring on the route; and
executing image analysis on the image to identify the event in the using a deep learning algorithm.

19. The non-transitory computer readable medium of claim 17, the operations further comprising:
identifying a loan portfolio including a collection of loans including the loan;
normalizing the risk value against other risk values of other loans in the collection of loans in the loan portfolio; and
applying the risk value on the loan portfolio.

20. The non-transitory computer readable medium of claim 17, the operations further comprising:
receiving data associated with the vehicle from a device disposed in the vehicle; and
turning on a camera based on data received from the device.
